(19) United States
(12) Patent Application Publication
(10) Pub. No.: US 2023/0418234 A1
(43) Pub. Date: Dec. 28, 2023

(54) Decorating Method Of Dial, Dial, And Timepiece

(71) Applicant: SEIKO EPSON CORPORATION, Tokyo (JP)

(72) Inventors: Shogo KOBAYASHI, Shiojiri (JP); Ai YOSHINAGA, Shiojiri (JP); Hajime HIRANO, Shiojiri (JP); Toshiyuki KUNO, Shiojiri (JP)

(21) Appl. No.: 18/341,010

(22) Filed: Jun. 26, 2023

(30) Foreign Application Priority Data
Jun. 27, 2022 (JP) 2022-102437

(51) Int. Cl. G04D 3/00; G04B 19/10; G04B 45/00

(52) U.S. Cl. CPC G04D 3/0069; G04B 19/10; G04B 45/0084

(57) ABSTRACT

A dial includes a recessed portion formed by laser irradiation, and a decorative portion formed at a bottom surface of the recessed portion by laser irradiation, including a first groove extending in a first direction, and a second groove extending in a second direction intersecting the first direction, and including a plurality of protruding portions provided in a region partitioned by a plurality of the first grooves, and a plurality of the second grooves.

The present application is based on, and claims priority from JP Application Serial Number 2022-102437, filed Jun. 27, 2022, the disclosure of which is hereby incorporated by reference herein in its entirety.

### BACKGROUND

### 1. Technical Field

The present disclosure relates to a decorating method of a dial, a dial, and a timepiece including the dial.

### 2. Related Art

There has been known a technique of decorating a timepiece component such as a dial by laser processing. For example, JP 2022-11407 A discloses a decorating method that enables various lightness expressions by providing a timepiece component with a plurality of grooves by using laser processing. More specifically, the various lightness expressions have been enabled by providing a part having a small groove depth, and a part having a large groove depth, to change a degree of reflection of light.

For example, FIG. 17 of JP 2022-11407 A shows a change in lightness when a plurality of grooves are formed in a lattice pattern at a base material made of nickel silver, and a depth of the groove is changed. According to FIG. 17, the lightness in L* when the depth of the groove is 100 μm is about 13. When the lightness in L* is 13, a decorative portion becomes black, has high contrast with respect to silver white nickel silver, and is clearly observed, thus, for example, it is considered that application to an hour indicator of a dial is suitable.

However, there has been room for improving the decorating method of JP 2022-11407 A. For example, when an hour indicator applied with lattice-like decoration is provided at a white-based dial, the black hour indicator is clearly observed in the white background, but there has been a problem in that a stereoscopic effect is poor. This is because the hour indicator is decorated so as to be flush with a front surface of the dial.

In addition, it is conceivable that abbreviated characters serving as an hour indicator are embedded at the dial to obtain a stereoscopic effect, but in this case, it is necessary to provide a hand above the abbreviated characters, thus it was difficult to achieve a reduction of a thickness.

In other words, there has been a demand for a decorating method exerting a stereoscopic effect while achieving a reduction of a thickness.

### SUMMARY

A decorating method of a dial according to an aspect of the present application includes a first step of forming a recessed portion by first laser irradiation, and a second step of forming a groove at least at a part of the recessed portion by second laser irradiation.

A dial according to an aspect of the present application includes a recessed portion formed by laser irradiation, and a decorative portion formed at a bottom surface of the recessed portion by laser irradiation, including a first groove extending in a first direction, and a second groove extending in a second direction intersecting the first direction, and including a plurality of protruding portions provided in a region partitioned by a plurality of the first grooves and a plurality of the second grooves.

A timepiece according to an aspect of the present application includes the above-described dial, and hands including an hour hand and a minute hand.

### BRIEF DESCRIPTION OF THE DRAWINGS

FIG. 1 is a front view of a timepiece according to Embodiment 1.

FIG. 2 is a cross-sectional view taken along line b-b of FIG. 1.

FIG. 3 is a perspective view of a decorative portion.

FIG. 4 is a flowchart illustrating a flow of a decorating method of an hour indicator.

FIG. 5 is a schematic configuration diagram of a laser processing apparatus.

FIG. 6 is an enlarged view of a part c of FIG. 2.

FIG. 7 is a graph showing a correlation between depth of a first groove and lightness.

FIG. 8 is an enlarged photograph of the hour indicator applied with decoration.

FIG. 9 is a plan view of an hour indicator according to Embodiment 2.

FIG. 10 is a cross-sectional view of an hour indicator according to Embodiment 3.

### DESCRIPTION OF EXEMPLARY EMBODIMENTS

### Embodiment 1

### Overview of Timepiece

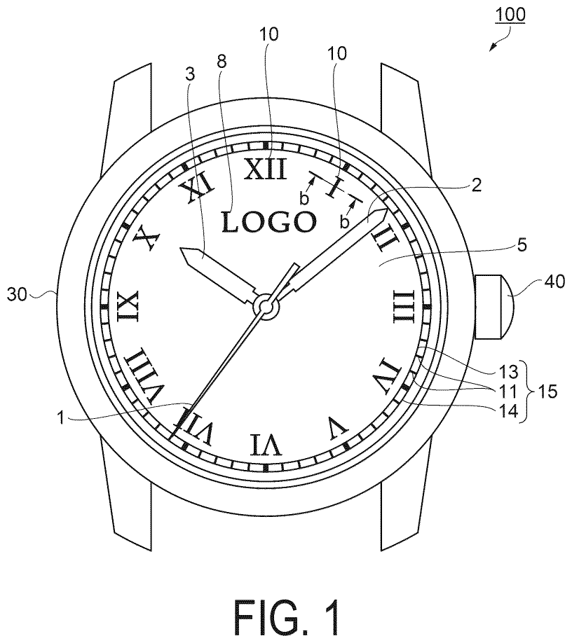

FIG. 1 is a front view of a timepiece.

Exemplary embodiments of the present disclosure will be described below with reference to the accompanying drawings.

A timepiece 100 of the present embodiment is a three-hand type analog wristwatch.

The timepiece 100 includes a case body 30, a dial 5, a seconds hand 1, a minute hand 2, an hour hand 3, a crown 40, and the like.

The case body 30 is a case, and is made of a hard metal such as stainless steel or titanium. Note that, a movement (not illustrated) for driving the hand is housed behind the dial 5 in the case body 30.

The dial 5 is provided with a logo 8, an hour indicator 10, a minute indicator 11, and the like. An insertion hole (not illustrated) through which a shaft of the hand passes is formed at a center of the dial 5 in a circular shape, and the seconds hand 1, the minute hand 2, and the hour hand 3 are attached.

The logo 8 is a logo representing a brand name or a product name of the timepiece 100.

Roman numerals are used for the hour indicator 10, and at 1 o'clock to 12 o'clock positions, corresponding Roman numerals are arranged.

The minute indicator 11 is provided as a part of a railway 15. The railway 15 is configured by arranging the minute indicator 11 corresponding to a sleeper, at two rail-like annular portions formed by an inner peripheral circle 13 and an outer peripheral circle 14. The minute indicator 11 is arranged in a bar shape at a position corresponding to each of a first minute to a 60th minute in the annular portion. Note that, the annular portions formed by the inner peripheral circle 13 and the outer peripheral circle 14 are an example of a pattern. Further, the minute indicator 11 also serves as a seconds indicator. The minute indicator 11 and the hour indicator 10 are collectively referred to as an indicator.

The crown 40 is a winder, and is provided so that time can be corrected when pulled by one step. Note that, other functions may be included.

In a preferred example, nickel silver is used for the dial 5, and a front surface thereof exhibits a silver-white color with metallic luster. Then, the hour indicator 10 is formed as a black indicator by decorating a part of the dial 5 by laser irradiation described later. In particular, since a black part is processed to be dug down, a configuration is obtained so that the black hour indicator 10 is stereoscopically observed with the silver-white color as a base.

Configuration of Hour Indicator

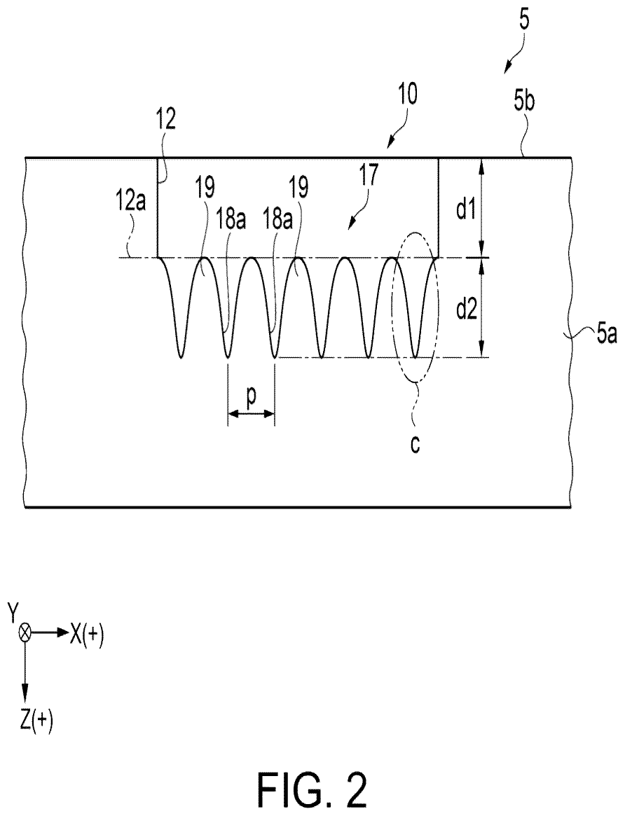

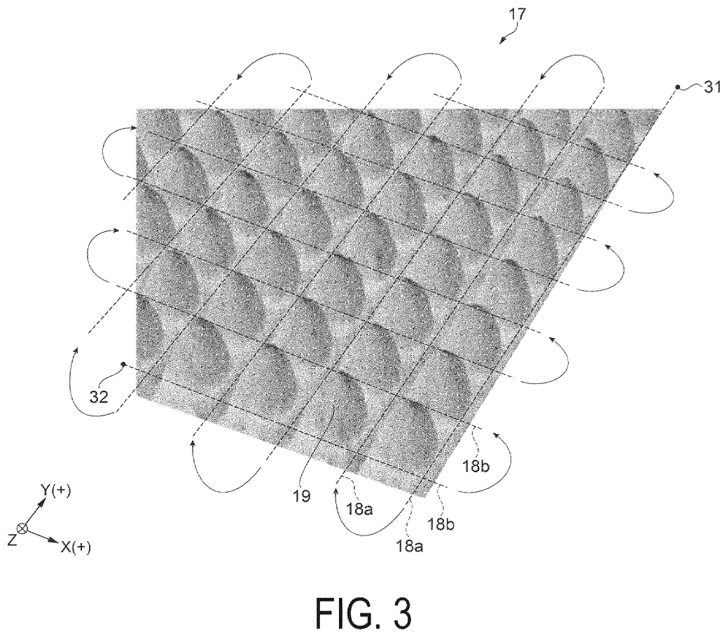

FIG. 2 is a cross-sectional view taken along line b-b of FIG. 1, and illustrates a cross section of the 1 o'clock hour indicator 10. FIG. 3 is a perspective view of a decorative portion. Note that, an X-axis, a Y-axis, and a Z-axis that are three axes orthogonal to each other are illustrated in each figure. A plane including the X-axis and the Y-axis is a plane along a front surface 5b of the dial 5, and a +Z direction indicates a thickness direction of the dial 5.

As illustrated in FIG. 2, the hour indicator 10 is configured with a recessed portion 12 dug down along a shape of the hour indicator 10 from the front surface 5b of the dial 5, and a decorative portion 17 including a plurality of protruding portions 19 formed by being dug down from a bottom surface 12a of the recessed portion 12.

The recessed portion 12 is a part dug down by one step from the front surface 5b of the dial 5 along the shape of the hour indicator 10, and is dug down by a dimension d1 from the front surface 5b in FIG. 2. By providing the recessed portion 12, the hour indicator 10 is stereoscopically configured. In other words, the recessed portion 12 is a depression with the bottom surface 12a being substantially flat.

The decorative portion 17 is formed at the bottom surface 12a of the recessed portion 12, and is configured to include a first groove 18a extending in a +Y direction as a first direction, and a second groove 18b extending in a +X direction as a second direction intersecting the +Y direction (FIG. 3). Then, the decorative portion 17 has the plurality of protruding portions 19 provided in a region partitioned by the plurality of first grooves 18a and the plurality of second grooves 18b. The first groove 18a and the second groove 18b are dug down from the bottom surface 12a by a dimension d2. In other words, a height of the protruding portion 19 is the dimension d2. In the present embodiment, the plurality of first grooves 18a and the plurality of second grooves 18b are formed entirely at the bottom surface 12a of the recessed portion 12.

Further, an arrangement pitch p of the adjacent first grooves 18a is set to about 0.035 mm in a preferred example. Note that, the present disclosure is not limited thereto, and it is sufficient that the arrangement pitch p is from 0.025 mm to 0.075 mm. Note that, an arrangement pitch of the second grooves 18b (FIG. 3) is the same as the arrangement pitch p of the first grooves 18a.

As illustrated in FIG. 3, the protruding portion 19 has a small hemispherical tip, and has a conical shape as a whole, and is formed in each region partitioned by the first groove 18a and the second groove 18b. In other words, the plurality of protruding portions 19 are dug out by the two intersecting first groove 18a and second groove 18b. The first groove 18a and the second groove 18b are formed by performing laser irradiation for a plurality of times.

Manufacturing Method of Hour Indicator

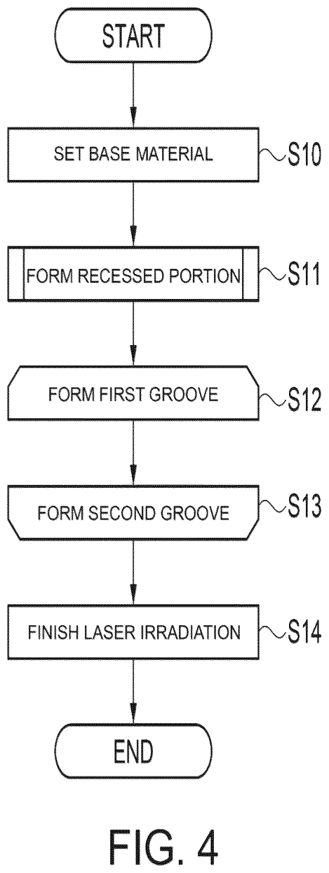

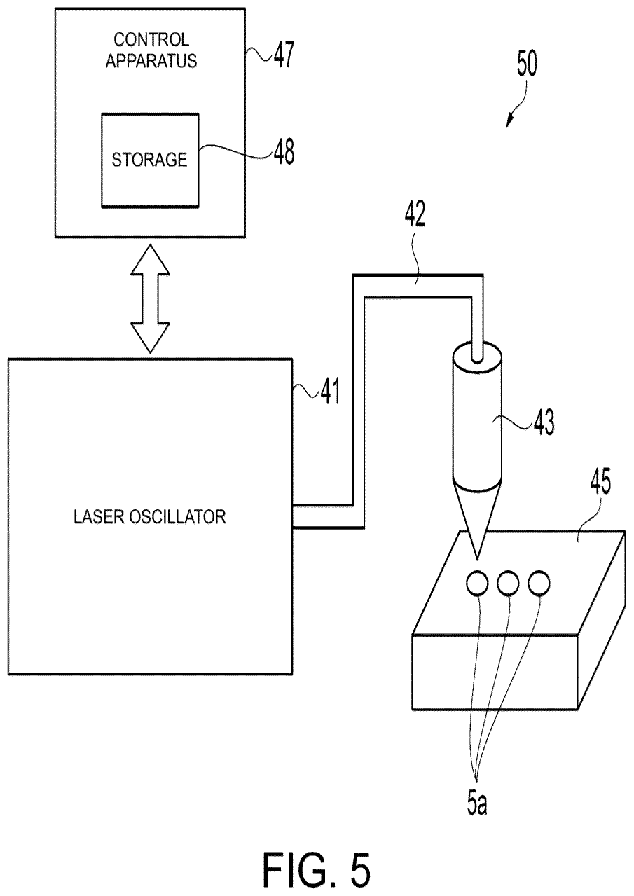

FIG. 4 is a flowchart illustrating a flow of a decorating method of the hour indicator. FIG. 5 is a schematic configuration diagram of a laser processing apparatus.

Next, the decorating method of the hour indicator 10 will be described mainly with reference to FIG. 4.

In Step S10, a base material 5a of the dial 5 is set in a laser processing apparatus 50. Specifically, an operator sets the base material 5a to be processed on a processing table 45 of the laser processing apparatus 50 illustrated in FIG. 5. Note that, at the same time as the setting of the base material 5a, a decoration program is activated in a control apparatus 47 of the laser processing apparatus 50. As the base material 5a, for example, a plate material made of nickel silver with a thickness of about 0.3 mm is used. Note that, the present disclosure is not limited to the material, and it is sufficient to use metal, for example, brass may be used, a noble metal such as gold, silver, or platinum may be used, or copper, stainless steel, or the like may be used. Alternatively, an alloy of the above metal may be used.

Since the laser processing apparatus 50 mainly operates in step S11 and subsequent steps, a schematic configuration of the laser processing apparatus 50 will be described first, with reference to FIG. 5.

The laser processing apparatus 50 includes a laser oscillator 41, a transmission optical system 42, an irradiation unit 43, the processing table 45, the control apparatus 47, and the like.

As a preferred example, a YAG (Yttrium Aluminum Garnet) laser is adopted as the laser oscillator 41. Note that, it is sufficient to use an apparatus capable of performing similar laser irradiation, and for example, a CO₂ laser or a fiber laser may be used.

The transmission optical system 42 is an optical path for transmitting laser light generated by the laser oscillator 41 to the irradiation unit 43, and is configured to include a plurality of reflection mirrors.

The irradiation unit 43 is an irradiation nozzle that condenses laser light and irradiates a workpiece, and is configured to include a condensing lens.

The processing table 45 is an XY table, and moves a workpiece placed thereon in a plane according to a scanning path pattern of laser irradiation in accordance with an instruction from the control apparatus 47.

The control apparatus 47 is a controller of the laser processing apparatus 50, is configured to include one or a plurality of processors, and integrally controls operation of each unit. The control apparatus 47 includes a storage 48 including a nonvolatile memory. The storage 48 stores a control program for controlling operation of the laser processing apparatus 50, a decoration program to be described later, various types of data, and the like. In the decoration program, an order and contents for forming the recessed portion 12 and the groove are defined, and in the various types of data, irradiation conditions, and scanning path pattern data are stored. Note that, examples of the irradiation conditions include parameters such as an output frequency, a scanning speed, a laser output, and a scanning path pitch.

Reference is now made back to FIG. 4.

In step S11, the recessed portion 12 is formed in accordance with the decoration program. More specifically, as illustrated in FIG. 2, the front surface 5b of the base material 5a is irradiated with laser for a plurality of times along the shape of the hour indicator 10 to form the recessed portion 12 dug down by the dimension d1. In a preferred example, an inside of the shape of the hour indicator 10 is uniformly and repeatedly scanned and irradiated by femtosecond pulse laser irradiation, to be dug down by the dimension d1. Note that, although picosecond or nanosecond pulsed laser irradiation may be used in order to increase processing efficiency, femtosecond pulsed laser irradiation may be used at a part where high processing accuracy is required such as a contour part. Further, a depth (dimension d1) of the recessed portion 12 is, for example, 50 μm. Note that, the depth is not limited to this, and it is sufficient to set the depth in accordance with a desired stereoscopic effect, and the depth may be from 50 μm to 200 μm. Note that, step S11 corresponds to a first step, and the laser irradiation when forming the recessed portion 12 corresponds to first laser irradiation.

From step S12 to step S13, laser irradiation for forming the first groove 18a, and laser irradiation for forming the second groove 18b are repeated according to the decoration program. For example, as illustrated in FIG. 3, laser irradiation is started from a start point 31, and when the irradiation of the first groove 18a is ended, then the adjacent first groove 18a is irradiated as indicated by an arrow, and when the irradiation of the first groove 18a is ended, the adjacent first groove 18a is irradiated as indicated by an arrow, so that all the first grooves 18a are irradiated in a zigzag manner with a single stroke. Next, when laser irradiation is started from a start point 32, and when the irradiation of the second groove 18b is ended, then the adjacent second groove 18b is irradiated as indicated by an arrow, and all the second grooves 18b are similarly irradiated with a single stroke also for the second grooves 18b. Then, this series of single-stroke irradiation is repeated for a predetermined number of times. In this way, by performing irradiation with a single stroke, unnecessary movement is reduced, and production efficiency can be improved.

Note that, steps S12 and S13 correspond to a second step, and the laser irradiation for forming the first groove 18a and the second groove 18b corresponds to second laser irradiation. In a preferred embodiment, the second laser irradiation is performed with femtosecond pulsed laser irradiation. In other words, the decorating method includes the first step of forming the recessed portion 12 by the first laser irradiation, and the second step of forming the groove at least at a part of the recessed portion 12 by the second laser irradiation. Note that, the irradiation conditions are appropriately set according to a material of the dial 5, and a depth of the groove, but for example, the conditions described in JP 2022-11407 may be used.

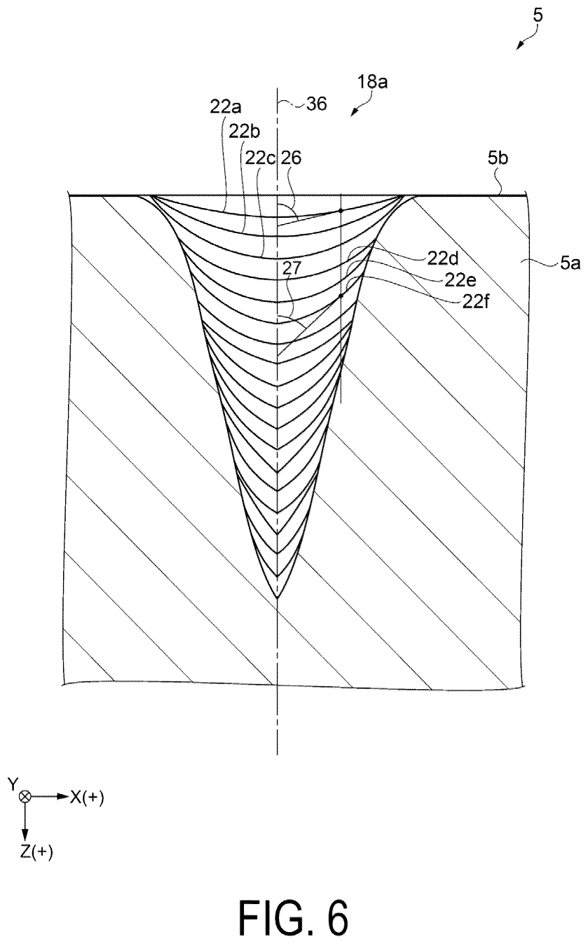

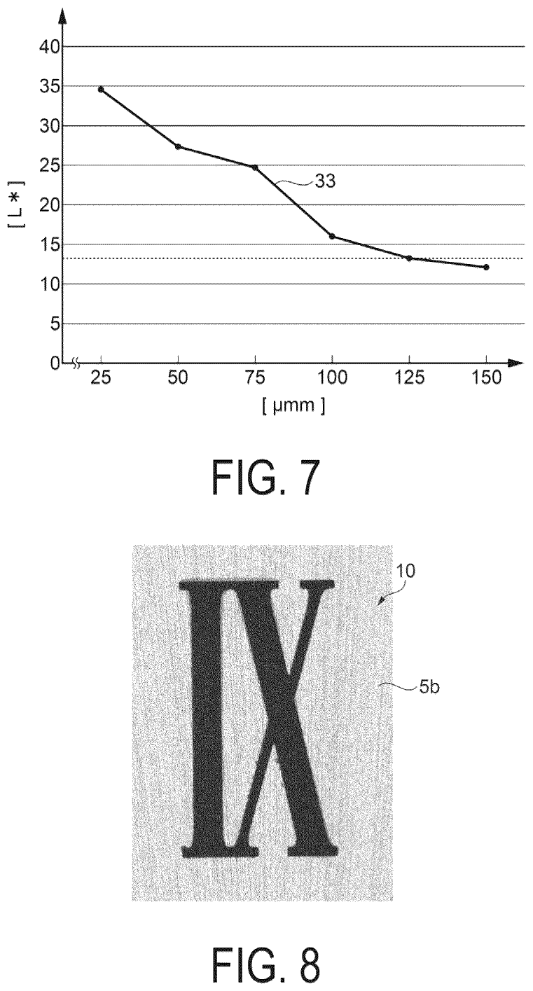

FIG. 6 is an enlarged view of the part c of FIG. 2. FIG. 7 is a graph showing a correlation between the depth of the first groove and lightness.

FIG. 6 is an enlarged cross-sectional view of the first groove 18a, and illustrates tracks by laser irradiation performed for a plurality of times, in a shape of annual rings. Specifically, a track of a groove formed by the first laser irradiation is a track 22a, a track formed by the second laser irradiation is a track 22b, subsequently, similarly, a track formed by the third laser irradiation is a track 22c, a track formed by the fourth laser irradiation is a track 22d, so that the tracks are illustrated in multiple stages.

As illustrated in FIG. 6, the first groove 18a is gentle near an opening portion, and becomes steeper as the depth increases. Therefore, an angle 26 formed by a tangent line along an inclination of the track 22a at the first stage and a center line 36 of the first groove 18a is larger than an angle 27 formed by a tangent line along an inclination of a track 22f at a sixth stage and the center line 36 of the first groove 18a. The same applies to the second groove 18b.

Here, most of the light incident on the first groove 18a is absorbed in the first groove 18a, due to attenuation caused by repeated reflection between side walls in the first groove 18a, and absorption by the side walls. Accordingly, when the first groove 18a is deeper, the groove is darker, and thus the entire decorative portion 17 including the plurality of grooves also becomes dark. In other words, when the height of the protruding portion 19 is larger, the entire decorative portion 17 is darker.

A graph 33 shown in FIG. 7 shows the correlation between the depth of the first groove 18a and the lightness. A horizontal axis indicates the depth of the groove in μm, and a vertical axis indicates the lightness in L*. Note that, the depth of the groove corresponds to the dimension d2 (FIG. 2).

Here, targeted lightness in L* at the hour indicator 10 of the dial 5 is 13, which is indicated by a dotted line. This is an index for obtaining the hour indicator 10, which is clear and black, at the silver-white dial 5.

As shown in the graph 33, it can be seen that the lightness decreases as the depth of the groove increases, and when the depth reaches 100 μm, target lightness 13 in L* is approached. Although depending on the material and design of the dial 5, the depth of the first groove 18a and the depth of the second groove 18b (dimension d2) may be from 25 μm to 150 μm. In addition, when it is desired to further clarify contrast with the dial 5, the depth of the first groove 18a and the depth of the second groove 18b (dimension d2) may be set to from 100 μm to 150 μm.

Reference is now made back to FIG. 4.

In Step S14, since the series of processing by the decoration program is ended, the laser irradiation is finished.

### Practical Embodiment of Hour Indicator

FIG. 8 is an enlarged photograph of the hour indicator applied with decoration.

The hour indicator 10 illustrated in FIG. 8 is in an enlarged photograph of the 9 o'clock hour indicator processed by the above-described decorating method. The depth of the recessed portion 12 (dimension d1) is 50 μm, and the depth of the first groove 18a and the depth of the second groove 18b (dimension d2) are 100 μm.

As illustrated in FIG. 8, the hour indicator 10 is stereoscopically observed with respect to the front surface 5b of the dial 5. Although it is difficult to understand because the photograph is taken from the front, in particular, the hour indicator 10 is more stereoscopically observed at an upper part thereof. Note that, by increasing the depth of the recessed portion 12, the stereoscopic effect can be further enhanced. Further, it can be seen that the black hour indicator 10 is clearly observed with high contrast, with the silver-white color of the dial 5 as a base.

As described above, according to the decorating method, the dial 5, and the timepiece 100 of the present embodiment, the following advantages can be obtained.

The decorating method of the present embodiment includes step S11 as the first step of forming the recessed portion 12 by the first laser irradiation, and steps S12 and S13 as the second step of forming the groove at least at a part of the recessed portion 12 by the second laser irradiation.

Accordingly, it is possible to realize the hour indicator 10 in which the decorative portion 17 is provided at the bottom surface 12a dug down by one step due to the recessed portion 12 from the front surface 5b of the dial 5. Therefore, unlike an existing hour indicator in which a decorative portion is provided to be flush with the front surface 5b of the dial 5, according to the hour indicator 10 of the present embodiment, the stereoscopic hour indicator 10 can be configured.

Furthermore, since there is no need to embed abbreviated characters in the dial 5, the hands can be arranged directly above the dial 5, and the timepiece 100 can be made thinner.

Therefore, it is possible to provide the decorating method of the dial 5 which is thin and exerts a stereoscopic effect.

In addition, the recessed portion 12 may be a depression with the bottom surface 12a being substantially flat.

Accordingly, since the decorative portion 17 can be provided at a deeper position by one step from the front surface 5b of the dial 5, the hour indicator 10 can be configured stereoscopically.

Further, the grooves of the decorative portion 17 include the first groove 18a extending in the first direction, and the second groove 18b extending in the second direction intersecting the first direction, and the protruding portion 19 is formed in the region partitioned by the plurality of first grooves 18a and the plurality of second grooves 18b.

Accordingly, by adjusting the depth of the first groove 18a and the depth of the second groove 18b, it is possible to form the decorative portion 17 having desired lightness.

Further, the plurality of first grooves 18a and the plurality of second grooves 18b are formed entirely at the bottom surface 12a of the recessed portion 12.

Accordingly, for example, when the present disclosure is applied to the hour indicator 10, the entire hour indicator can have a uniform texture with the lightness of the decorative portion 17.

Further, the depth of the recessed portion 12 is from 50 μm to 200 μm, and the depth of the first groove 18a and the depth of the second groove 18b from the bottom surface 12a of the recessed portion 12 are from 25 μm to 150 μm. Accordingly, since the decorative portion 17 is provided at a part dug down by one step due to the recessed portion 12 from the front surface 5b of the dial 5, it is possible to form the hour indicator 10 exerting a stereoscopic effect.

Further, the depth of the first groove 18a and the depth of the second groove 18b from the bottom surface 12a of the recessed portion 12 may be from 100 μm to 150 μm.

Accordingly, since the lightness of the decorative portion 17 decreases, the contrast with the dial 5 increases, and the hour indicator 10 can be made clearer.

Further, the first laser irradiation and the second laser irradiation may be femtosecond laser irradiation.

Accordingly, it is possible to perform fine processing requiring accuracy for a contour of the hour indicator 10, the first groove 18a, the second groove 18b, or the like with high accuracy.

The dial 5 includes the recessed portion 12 formed by laser irradiation, the first groove 18a formed at the bottom surface 12a of the recessed portion 12 by laser irradiation, and extending in the first direction, and the second groove 18b extending in the second direction intersecting the first direction, and is provided with the plurality of protruding portions 19 provided in the region partitioned by the plurality of first grooves 18a and the plurality of second grooves 18b.

Accordingly, it is possible to provide the dial 5 provided with the hour indicator 10 applied with the decoration exerting a stereoscopic effect.

The timepiece 100 includes the dial, 5 and the hands including the hour hand 3 and the minute hand 2.

Accordingly, it is possible to provide the thin timepiece 100 provided with the dial 5 provided with an indicator exerting a stereoscopic effect.

### Embodiment 2

Configurations with Different Hour Indicator—1

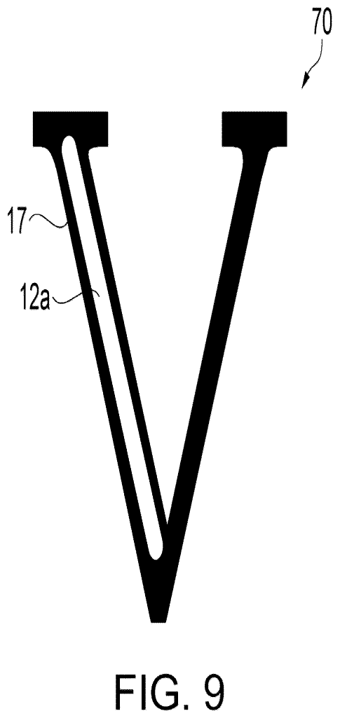

FIG. 9 is a plan view of an hour indicator according to Embodiment 2, and corresponds to FIG. 8.

In the above-described embodiment, the decorative portion 17 has been described to be provided at the entire bottom surface 12a of the recessed portion 12, however, the present disclosure is not limited to the configuration, and the decorative portion 17 may be provided at a part of the bottom surface 12a.

For example, in an hour indicator 70 of the present embodiment, a part without the decorative portion 17 is provided at a part thereof. The same constituent portions as those in the above-described embodiment are given the same reference signs, and overlapping description thereof will be omitted.

The hour indicator 70 illustrated in FIG. 9 is the 5 o'clock hour indicator, and a part in which the bottom surface 12a is exposed is provided at an inside of a left line. In other words, in the left line, the decorative portion 17 is provided at a contour part, but the bottom surface 12a is left as it is at the inside. The decorative portion 17 is provided at an entire surface of a right line.

According to the hour indicator 70, it is possible to add an accent to design without impairing a stereoscopic effect.

Reference is now made back to FIG. 1.

In the above, the hour indicator 10 has been described to be provided with the recessed portion 12 and the decorative portion 17, but the present disclosure is not limited thereto, and both may be provided at an indicator, a pattern, or a logo provided at the dial 5.

For example, the recessed portion 12 and the decorative portion 17 may be provided at the logo 8, the minute indicator 11, and the railway 15 at the dial 5 of FIG. 1. Further, the decorative portion 17 is not limited to be provided at the entire surface of the concave portion 12, but may be provided at a part of the recessed portion 12. In other words, the recessed portion 12 and the decorative portion 17 are provided at a portion of an indicator, a pattern, or a logo.

As described above, according to the decorating method, and the timepiece 100 of the present embodiment, the following advantages in addition to the advantages of the above embodiments can be achieved.

In the hour indicator 70, the decorative portion 17 is provided at a part of the bottom surface 12a, and the bottom surface 12a remains at a part where the decorative portion 17 is not provided.

Accordingly, it is possible to provide the hour indicator 70 in which an accent is added to the design without impairing the stereoscopic effect.

In addition, the recessed portion 12 and the decorative portion 17 are provided at a portion of an indicator, a pattern, or a logo. Accordingly, the indicator, the pattern, or the logo, which is stereoscopic and clear, can be provided at the dial 5. In addition, since it is possible to individually adjust the stereoscopic effect and the lightness, by changing the depth of the recessed portion 12 or the depth of the decorative portion 17 in each site, it is possible to realize various types of design, and it is possible to improve the design of the dial 5.

### Embodiment 3

Configurations with Different Hour Indicator—2

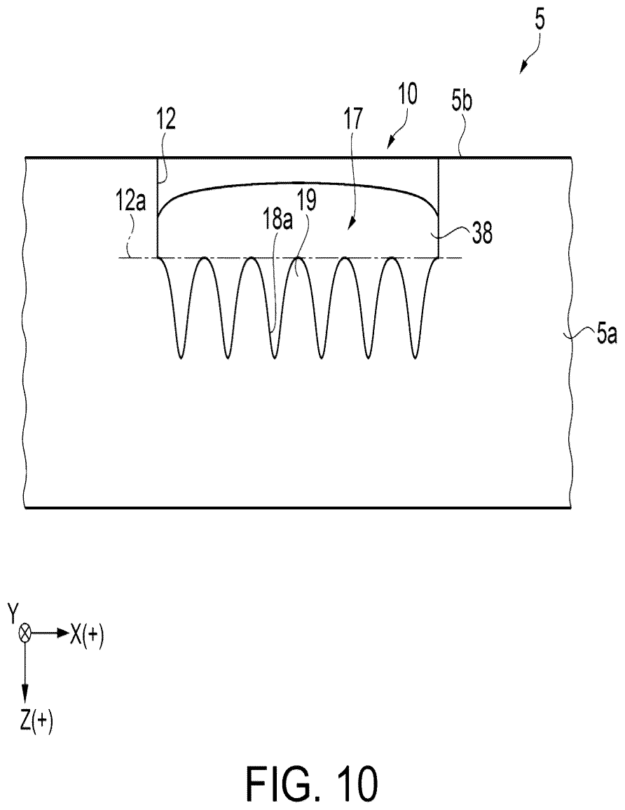

FIG. 10 is a cross-sectional view of an hour indicator according to Embodiment 3, and corresponds to FIG. 2.

As illustrated in FIG. 10, a clear layer 38 may be provided at a front surface of the hour indicator 10. The same constituent portions as those in the above-described embodiment are given the same reference signs, and overlapping description thereof will be omitted.

In the hour indicator 10 of the present embodiment, the clear layer 38 is provided above the decorative portion 17. The rest of the configuration is similar to the description with reference to FIG. 2.

In a preferred example, an acrylic resin is used as a material of the clear layer 38, and is applied onto the decorative portion 17 using a precision dispenser. The step of forming the clear layer 38 corresponds to a third step. Note that, it is sufficient that the clear layer 38 is made of a transparent resin material, and for example, a cellulose resin, a polyurethane resin, an acrylic lacquer resin, or the like may be used.

As described above, according to the decorating method, and the timepiece 100 of the present embodiment, the following advantages in addition to the advantages of the above embodiments can be achieved.

The decorating method of the present embodiment further includes the third step of forming the clear layer 38 that covers the first groove 18a, the second groove 18b, and the protruding portion 19.

Accordingly, it is possible to further enhance the stereoscopic effect of the hour indicator 10. Further, adhesion of dust to the hour indicator 10 can be prevented.

What is claimed is:

1. A decorating method of a dial, comprising:
a first step of forming a recessed portion by first laser irradiation; and
a second step of forming a groove by second laser irradiation at least at a part of the recessed portion.

2. The decorating method of a dial according to claim 1, wherein
the recessed portion is a depression with a bottom surface being substantially flat.

3. The decorating method of a dial according to claim 2, wherein
the groove includes
a first groove extending in a first direction, and
a second groove extending in a second direction intersecting the first direction, and
a protruding portion is formed at a region partitioned by a plurality of the first grooves and a plurality of the second grooves.

4. The decorating method of the dial according to claim 3, wherein
the plurality of first grooves and the plurality of second grooves are formed entirely at the bottom surface of the recessed portion.

5. The decorating method of a dial according to claim 3, wherein
a depth of the recessed portion is from 50 μm to 200 μm, and
a depth of the first groove from the bottom surface of the recessed portion and a depth of the second groove from the bottom surface of the recessed portion are from 25 μm to 150 μm.

6. The decorating method of a dial according to claim 5, wherein
a depth of the first groove from the bottom surface of the recessed portion and a depth of the second groove from the bottom surface of the recessed portion are from 100 μm to 150 μm.

7. The decorating method of a dial according to claim 3, further comprising a third step of forming a clear layer configured to cover the first groove, the second groove, and the protruding portion.

8. The decorating method of a dial according to claim 3, wherein
the first laser irradiation and the second laser irradiation are femtosecond laser irradiation.

9. A dial, comprising:
a recessed portion formed by laser irradiation; and
a decorative portion
formed by laser irradiation at a bottom surface of the recessed portion,
including a first groove extending in a first direction and a second groove extending in a second direction intersecting the first direction, and
including a plurality of protruding portions provided at a region partitioned by a plurality of the first grooves and a plurality of the second grooves.

10. The dial according to claim 9, wherein
the recessed portion and the decorative portion are provided at a portion of an indicator, a pattern, or a logo.

11. A timepiece comprising:
the dial according to claim 9; and
a hand including an hour hand and a minute hand.
